(19) United States
(12) Patent Application Publication
(10) Pub. No.: US 2002/0175991 A1
(43) Pub. Date: Nov. 28, 2002

(54) GPI trigger over TCP/IP for video acquisition

(75) Inventors: Thomas Pflaum, Waltham, MA (US); Yuri Eidus, Newton, MA (US)

Correspondence Address: Ronald Abramson, Hughes Hubbard & Reed LLP, One Battery Park Plaza, New York, NY, 10004-1482, US

(73) Assignee: Anystream, Inc., Sterling, VA

(21) Appl. No.: 10/076,872

(22) Filed: Feb. 12, 2002

Related U.S. Application Data
(60) Provisional application No. 60/268,508, filed on Feb. 14, 2001.
(60) Provisional application No. 60/276,756, filed on Mar. 16, 2001.
(60) Provisional application No. 60/297,655, filed on Jun. 12, 2001.
(60) Provisional application No. 60/297,563, filed on Jun. 12, 2001.

(51) Int. Cl. H04N 7/00; H04N 5/225; H04N 5/76; H04N 5/91

(52) U.S. Cl. 348/22; 386/119

(57) ABSTRACT

A system for transmitting a trigger signal for a video capture system over a network, such as a TCP/IP network, which eliminates the need for special connections to be available in order to send triggers from an external device to start and stop the acquisition of video. Traditional video start/stop triggers are routed through a Trigger Converter which converts the trigger signal to a signal formatted for transmission over an existing network. A Trigger Receiver receives the formatted signal from the network and converts it to a trigger signal formatted for the trigger input of the video capture device. The video capture system responds to the trigger signal from the Trigger Receiver in the same way as it would have to the traditional trigger. Because the video capture device is already connected to the network, additional cables are not necessary.

This application claims benefit of U.S. provisional patent application serial No. 60/268,508 filed on Feb. 14, 2001; and also claims benefit of U.S. provisional patent application serial No. 60/276,756 filed on Mar. 16, 2001; and also claims benefit of U.S. provisional patent application serial Nos. 60/297,655 and 60/297,563, both of which were filed on Jun. 12, 2001.

### BACKGROUND OF THE INVENTION

1. Field of the Invention

This invention relates to the fields of Internet and Video. In particular, the invention is a system for sending frame-accurate triggers through existing networks, such as TCP/IP networks, to start and stop capturing audio and video.

2. Description of Related Art

Devices used for video processing and distribution have not traditionally been able talk to TCP/IP networks. Although newer devices have recently become available that include TCP/IP interfaces in addition to the older RS422 or GPI interfaces, the old ways of communicating triggers are still used. In order to start and stop the acquisition of video from an external device at the correct time, the following two approaches have been used:

1. Using RS232 and RS422 serial interface protocol

2. General Purpose Interrupts (GPI) sent over designated cables through proprietary interfaces

However, these prior solutions solved the problem by using special connections (cables) to communicate the start and stop time to the video capture device. This requires extra wires to be available between the point at which the trigger is generated and the point at which the trigger is used. Further, the ability of these prior solutions to carry additional information along with the trigger is limited.

As the availability of TCP/IP interfaces in modem video processing and distribution devices increases, the need grows for a system to send a trigger from a remote device to a video capture device through the TCP/IP network. Using the TCP/IP network to send triggers between two devices eliminates the need for additional cables, which is required by the older solutions. Since the devices can be far apart within one building or even in different buildings, the cost savings in eliminating extra cable can be substantial.

In addition the TCP/IP trigger can be used to carry additional information, which cannot be done with GPI triggers, and to a much smaller degree with RS232/422 and DTMF tone triggers due to the lower available bandwidth.

### BRIEF SUMMARY OF THE INVENTION

The present invention eliminates the need for special connections to be available in order to send triggers from an external device to start and stop the acquisition of video. With the present invention, traditional video start/stop triggers are routed through a Trigger Converter, then transported through an existing TCP/IP network from the point of creation to a Trigger Receiver. Trigger information is then forwarded from the Trigger Receiver to the trigger input of a video capture system, which responds in the same way as it would have to the traditional trigger. Because the video capture device is already connected to the network, additional cables are not necessary.

With the present invention, triggers are communicated successfully through the TCP/IP network and achieve the required frame-accurate start and stop of video acquisitions without the need for additional cables. Further, removal of these additional cable paths reduces the installation and operating cost of video systems which require communication of such frame-accurate start and stop triggers.

### BRIEF DESCRIPTION OF THE DRAWINGS

FIG. 1 is a block diagram showing an overview of the present invention.

FIG. 2 is a block diagram of the TCP/IP Trigger Converter.

### DETAILED DESCRIPTION OF THE PREFERRED EMBODIMENTS

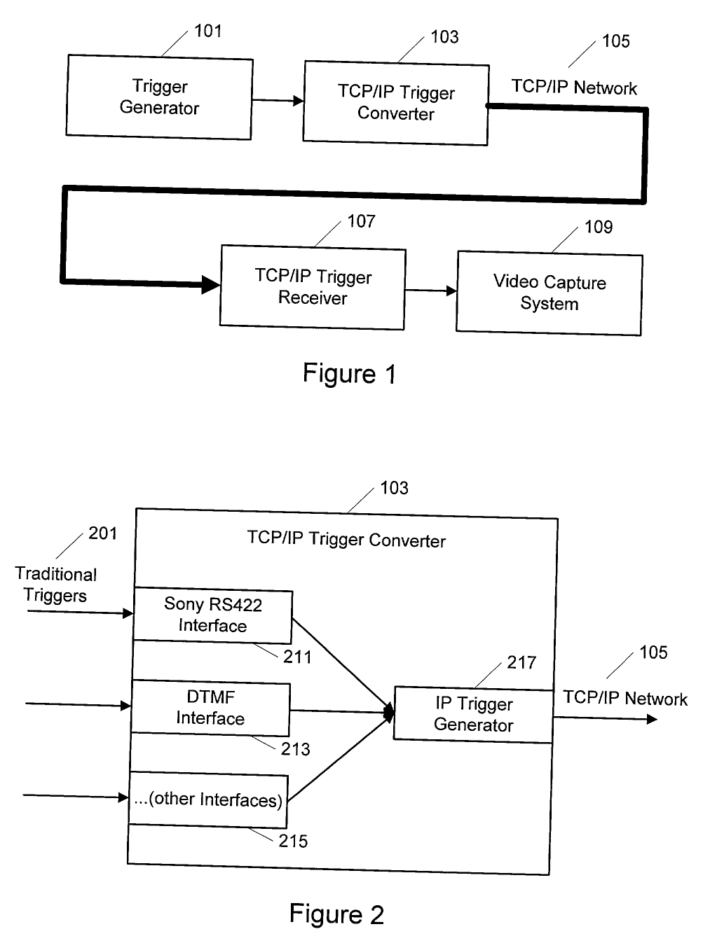

As shown in FIG. 1 and FIG. 2, an external device, a “Trigger Generator” 101, creates a trigger that is to be sent to a video capture device. Examples of triggers include DTMF tones inserted into broadcast television programming at the beginning of a commercial break, or messages sent by professional video tape recorders and similar devices to allow for frame-accurate capture of the video. The “TCP/IP Trigger Converter” 103 takes the trigger and converts it into a packet that can be sent over a TCP/IP network 105. The general architecture of the Trigger Converter 103 (see FIG. 2) allows for the conversion of almost any type of event (trigger 201) that can be received by a computer to be converted into an IP Trigger. Depending upon the type of trigger 201, the proper interface of the TCP/IP Trigger Converter 103 is used to read and decode the trigger 201. Additional information that is included with the trigger is extracted and passed to the IP Trigger Generator 217, which generates the packet that can be sent over the IP network. This packet, the IP Trigger, includes the additional information extracted from the trigger in addition to the trigger information itself.

In one embodiment, the Converter supports the conversion of the following types of triggers:

1. Sony RS422 deck control messages, received through the RS422/232 external interface port 211 of a standard computer. The Converter extracts the additional “timecode” information that is send with the RS422 deck control messages and includes it in the IP trigger.

2. General Purpose Interrupts (GPI) received through the GPI interface port of the video capture card.

3. DTMF tones 213 as used by broadcast television.

Other embodiments of the invention may convert various other types of triggers 215 without going beyond the scope of the present invention.

The generated TCP/IP packets are then transmitted over an existing network 105, for example an Ethernet 100BaseT network, to the “TCP/IP Trigger Receiver” 107. The TCP/IP Trigger Receiver 107 receives the IP packets generated by the Trigger Generator 217, and extracts any additional information included in the IP Trigger packet. The trigger is then forwarded to the “Video Capture System” 109, which reacts to the trigger in the same way it would react to a traditional trigger using, for example, RS422/RS232, GPI, or Sony RS422 deck control protocol.

We claim:

1. A system for transmitting a trigger signal for a video capture system over a network, comprising:
a trigger converter that converts said trigger signal to a signal formatted for transmission over said network, and
a trigger receiver that receives said formatted signal from said network and converts it to a trigger signal formatted for the trigger input of said video capture system.
